(19) United States
(12) Patent Application Publication
(10) Pub. No.: US 2020/0386880 A1
(43) Pub. Date: Dec. 10, 2020

(54) ACTIVITY DETECTION FOR MOBILE DEVICE USING RADAR

(71) Applicant: Metawave Corporation, Carlsbad, CA (US)

(72) Inventor: Sandra Lynn Godsey, Carlsbad, CA (US)

(21) Appl. No.: 16/810,298

(22) Filed: Mar. 5, 2020

Related U.S. Application Data
(60) Provisional application No. 62/814,178, filed on Mar. 5, 2019.

(51) Int. Cl. G01S 13/56; G06K 9/00; H04W 64/00

(52) U.S. Cl. CPC G01S 13/56; G06K 9/00664; H04W 4/40; H04W 64/003; H04W 64/006

(57) ABSTRACT

Examples disclosed herein relate to a mobile device adapted to provide an alert of a dangerous activity or trigger situation. An environmental sensing unit may be a radar unit that identifies potential intersection with a target, such as a vehicle or obstacle in a user's path. In a 5G network, the infrastructure components may provide an alert to the mobile device.

### CROSS-REFERENCE TO RELATED APPLICATIONS

This application claims priority from U.S. Provisional Application No. 62/814,178, titled “Activity Detection for Mobile Device Using Radar,” filed on Mar. 5, 2019, and incorporated herein by reference in its entirety.

### FIELD OF THE INVENTION

The present invention relates to activity detection in a mobile device using sensors, and specifically to radar sensing.

### BACKGROUND

Pedestrian accidents are on the rise. Much of this is due to inattention and distraction of drivers and pedestrians while on mobile devices. There is a need to provide pedestrians the ability to pay attention while engaged.

### BRIEF DESCRIPTION OF THE DRAWINGS

The present application may be more fully appreciated in connection with the following detailed description taken in conjunction with the accompanying drawings, which are not drawn to scale, in which like reference characters refer to like parts throughout, and in which:

FIG. 1 illustrates an activity detection system for a wireless device, and method therefor, according to various implementations of the subject technology;

FIG. 2 illustrates a block diagram of an activity detection system for a wireless device, according to various implementations of the subject technology;

FIG. 3 illustrates a radar module of an activity detection system for a wireless device, according to various implementations of the subject technology; and

FIG. 4 illustrates an activity detection system incorporating wireless communication infrastructures for a wireless device, according to various implementations of the subject technology.

### DETAILED DESCRIPTION

The present disclosure provides methods and apparatuses to provide attention to distracted pedestrians and other mobile device users. The addition of a radar sensing unit and alarm to the mobile device provides information to a user during usage. The mobile device may incorporate a radar or other sensor module that provides real time information to the mobile device and user. With expanded communications networks, the network and components therein may provide a safety net around users taking advantage of the visibility of other devices, such as 5G base stations capable of effectively tracking mobile devices.

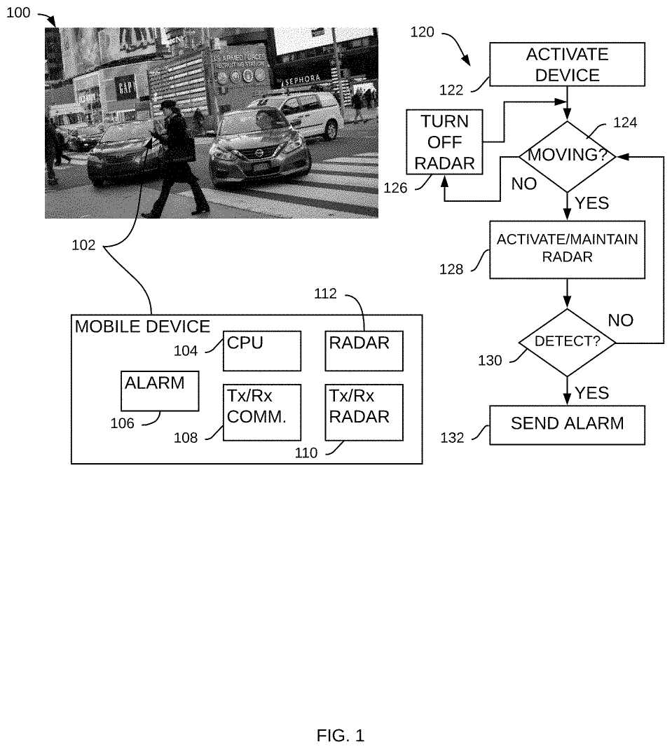

FIG. 1 illustrates a common scene in the world today, where users are distracted from what is happening in their environment by their interaction with a mobile device. As functionality on smart phones and devices increases, so does the distraction factor. The computing power, connectivity and applications available may be used to provide a safety net for the user.

In the scene of FIG. 1, a user having a mobile device 102 is walking across a street in a city block 102. There is a lot of activity, movement of vehicles, signs, traffic lights, other pedestrians and so forth. As illustrated, the user is totally distracted by her mobile device 102 to the exclusion of visibility and attention to the environment even though she is crossing a street. This scene is repeated millions of times each day for a variety of users, and causes problems walking on a sidewalk, crossing a street, walking through a parking lot and so forth.

In this illustrated implementation, the mobile device 102 includes a radar unit 112 for sensing activity around the mobile device. The mobile device 102 also includes transceivers for both communication 108 and radar 110 units and is controlled by a central processing unit 104. When an object is detected in the path of the user or which will cross paths with the user an alarm 106 notifies the user of the object's presence. The alarm may be a verbal warning from the mobile device, a movement of the device, a flash of light and so forth. In some implementations, the radar 112 initiates a video or camera shot of the instance or danger which is then presented on the screen as a real time video, photo or as a model of the situation. There are a variety of ways to provide guidance and warning to the user, including pausing all activity on the mobile device 102 to disrupt the distracting activity. This disruption may inject a message similar to a service announcement on the phone in audio, video or both.

The user will then be able to take action to avoid the danger or collision. In some implementations, the alarm 106 instructs the user to take a specific action. The alarm may show an arrow to the left indicating the user should move to the left, and so forth.

The alarm may also send a warning to vehicles in the vicinity so that the vehicles may avoid danger to the user. Similarly, information may be sent to other people in the vicinity who may be impacted by the current path of the user. This is applicable to cyclists, non-motorized movers and others having wireless communication capability.

A process 120 is illustrated that starts on activation of the mobile device, 122. Activation may be when a device is powered on or may be when the device is in a user mode, such as text, voice calls, or other modes. Detection of movement of the mobile device step 124 determines if radar 112 is to be used. If so, the radar 112 is activated on movement of an activated device, 128. Once the radar 112 is activated, operation is maintained while movement continues, 128. If the radar 112 detects a situation to trigger an alarm (situation trigger), 130, the alarm is initiated or sent to the user, 132. While the user is moving without a situation trigger the process returns to monitor movement, 124. The situation trigger may be a simple detection of a vehicle in the path of the user or may be designed to detect a variety of conditions, including objects in the path that may be a tripping hazard, stationary objects and so forth.

Once movement is not detected, 124, the process may turn off the radar 112, 126, or may have a time out period during which the process continues to monitor for movement. After the expiration of the time out period, the radar 112 is turned off or deactivated, 126. The system may for other reasons or in other situations may determine to turn the radar 112 off, 126, and wait for movement to begin, 124. These methods may be adapted to the situation, user activity and power level of the mobile device battery and so forth. As the features of mobile devices and their interconnectivity continues to develop, the ability of the mobile device 102 to provide alerts and warnings to a user increases in importance.

Alternate examples of the present technologies may implement other sensors, such as camera or ultrasound, which are able to identify specific obstacles in specific areas. The camera may be particularly useful as it is often pointed toward the ground and may quickly identify obstacles by disruption in a surface.

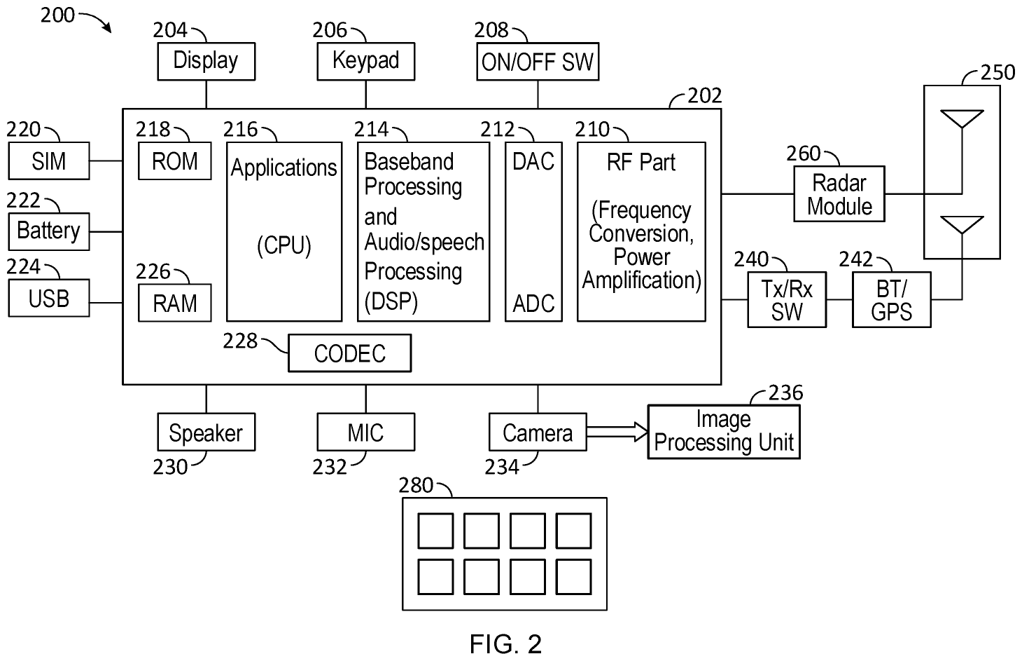

In the examples detailed herein a radar sensor is used with a cellular device. Other applications may employ a different sensor or sensors with other types of mobile devices. The mobile device 200 of FIG. 2 is such a device combination, including modules and components for operation of a mobile communication device, such as a 5G cell phone, and a radar module 260 for detection of objects in the vicinity and path of a user of the mobile device 200. The example considers a 5G device as this is a smart device operational in mobile networks having significantly different operation than conventional cellular networks. As Internet connectivity expands, the requirements and specifications for wireless communication expands with the desire to integrate mobile devices and wireless communication devices to access and interact with available information and other devices. The Internet of Things (IoT) turns many devices and systems into devices capable to connect, share and interact with users and other devices and systems. These smart devices are computer-controlled communication-capable devices with network connectivity capabilities. The 5G wireless communication system is specified to work with these devices by operating with precise directionally controlled antennas at much higher frequencies.

The 5G systems operate in contrast to the lower frequency transmissions of LTE and prior systems, which operated by omnidirectional beams or isotropic-type radiation. In these prior networks the base stations' transmission was received by any device in the coverage area of the base station, the cell. Individual mobile devices were able to receive messages and communications directed to them and not others by encoding schemes. The omnidirectional systems are subject to losses and reduced power on an individual one-to-one connection. The 5G radio transmission beams are directional beams as they are directed to each individual user. This directionality is provided by antennas capable of moving a beam in a specific direction. The directed transmission has a high transmission frequency to achieve the download and upload goals of the system. The 5G combination of high frequency, directionality, and low latency enables higher capacity for fast data. The goals of 5G directional antennas conserve power for use on specific communications; they offer fast, realistic video, more device connections, dramatically increased download speeds, and more to enable expansion of IoT devices, smart transportation, virtual reality and more.

The 5G standard supports device-to-device (D2D) for out-of-network communication among devices in close proximity. This ability enables devices in a vicinity to share information with each other and provide alerts to each other of trigger situations, as used herein. Additionally, 5G supports low-level device communication, referred to as machine-type communications such as with meters and other devices, making them able to respond to mobile devices when polled. The 5G network is a vast web of connections that may be used to increase safety and knowledge of individual users and mobile devices. In this way the conventional cells of a cellular system, which were relatively fixed areas, are now dynamically adjusted according to the usage and demand in a given area and may be used for new type of communications and purposes.

Continuing with FIG. 2, radar module 260 is coupled to module 202 which includes memory portions, ROM 218 and RAM 226, various applications with a central processing unit (CPU) 216, a baseband processing unit 214, analog to digital conversion circuits (ADC, DAC) 212, codec 228, and RF components 210 for managing baseband signals, frequency conversion, and amplification for over the air signals. The mobile device 200 also includes mechanical, power and port units, such as battery 222 and universal serial bus (USB) port 224, subscriber identity module (SIM) 220, user interface units, including display 204, keypad 206 and control switches 208. Additional user interface units include speaker 230, microphone 232 and camera 234.

In the example of FIG. 2, the transceiver 240 and GPS module 242 are specific to the communication operations of mobile device 200. The radar module 260 includes a dedicated transceiver; however alternate examples may implement a design to share processing, such as to share a transceiver for preparing and receiving both communication signals and radar signals. The antenna module 250 illustrates separate antennas for clarity of understanding, however, the mobile device 200 may share radiating element capability as a single antenna or an antenna array to support both communication and radar, such as by time division or other sharing scheme. The antenna module 250 is not limited but may be any type of antenna structure supporting communications and/or radar. An example antenna module 280 is an antenna array with multiple antenna elements; the antenna elements may be assigned to subarrays. The subarrays may be used for multiple-input multiple-output (MIMO) transmissions and/or for allocation of functionalities, wherein such subarrays are used to apply multiple antennas to one or more functionalities, including radar, communications and so forth. Processing of the received signals may be done in collaboration such that the radar module 260 may receive information extracted from the communication system, such as the base station, angle of arrival or other information as available describing the connection and from which the radar may make decisions. Information from additional modules, such as the camera 234 may also be used by the radar module 260. This co-location of sensors on a mobile device may also be used to provide information to other devices or to the communication or other network. As the IoT expands, there may be other networks operating separately from the communication network and these therefore multiple networks may be able to glean information from each other.

The mobile device 200 has methods for detecting movement of the user. Walking movement of a user holding the mobile device 200 is detected by various sensors, such as a accelerometer, gyroscope, global position system (GPS), compass and so forth. Detection of movement acts to trigger the alert radar module 260 operation as it is a trigger situation. In some examples, activities on the mobile device 200 are trigger situations for activating the radar module 260, such as initiating a voice call, reading text messages, and so forth.

Other sensors may be implemented in coordination with the radar module 260, such as the image processing unit 236 coupled to the camera 234, whereby the modules complement each other to provide information and alerts to the user. In a 5G communication system, infrastructure identifies a location of users and in some situations may identify two 5G users approaching each other, such a vehicle and a pedestrian. In this situation, the 5G system may send an alert to both, such alert to be displayed or otherwise presented on the mobile device 200. Various trigger situations may be added as they develop.

In some examples a mobile device may share an antenna(s) between radar operation and communication, such as when the mobile device is in a vehicle and no user alert is required. In this and other situations, the radar antenna is not functioning for radar detection but rather the antenna is used for improved wireless connectivity of the communication functions. The use of additional and multiple antennas improves power efficiency of the mobile device, critical at such high frequencies. With more power, more energy is directed as desired more robustly.

Automotive radar and 5G radios have similar components, such as phase shifters, local oscillators, RF amplifiers and mixers and so forth. An optimized design will reuse components for the multiple purposes where available. Modulation capability distinguishes radar from communications. As the radar is on a device that is in motion, as the user travels the device also receives radar echoes or reflections from moving targets. Moving targets may include vehicles, people, animals, and so forth, while stationary targets include trees, the road surface, nearby road signs, guard rails, streetlight poles and so forth. The radar module 260 compares the reflected signal frequency of the target with the transmitted signal frequency of the radar considering the background noise signal to provide a speed measure. The ability to detect objects and their speed, motion, velocity, acceleration and so forth measured through amplitude, frequency, Doppler shift and other measures provides additional information to an alert warning system.

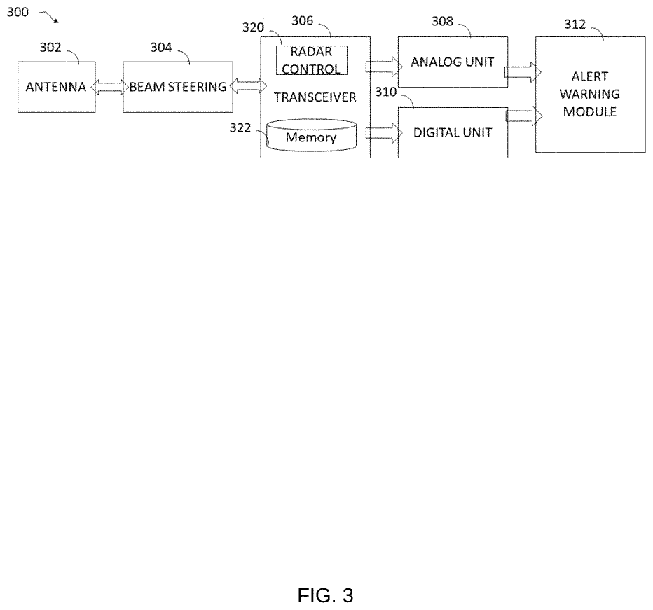

FIG. 3 illustrates a radar module 300 including a radiating element, antenna 302, and components for beam steering and beam forming module 304. The antenna 302 may be an antenna array of radiating elements. The beam steering and beam forming module 304 is coupled to transceiver 306 which then provides information to analog unit 308 and digital unit 310, which are able to determine if there is a trigger situation, such as an object in the path of the user, and provide input to alert warning module 312 to initiate a warning sequence or present an alert. In some examples, the mobile device pauses to capture the user's attention. In other examples, the warning may be a light or pattern on a display of the mobile device. A variety of alert mechanisms may be implemented, such as a special ringtone, a vibration and so forth. The mobile device including radar module 300 may track the user with the ability to predict future movement, path and activity. This information may be used to identify trigger situations. For example, where a morning commute path is known, the radar can detect trigger situations along that path with sufficient time for reaction.

Where mobile devices are able to communicate with each other directly, out of network, the alerts may also be sent to other parties in the vicinity. In some examples, the alert warning module sends a transmission through the wireless portion of the mobile device to alert a vehicle in the path, thus both parties to the potential incident are alerted. The radar module 300 may share components with the wireless portion of the mobile device (not shown) in which it resides. The transceiver 306 includes a radar controller 320 for managing modulation and control the radar signal, and also includes memory 322 storing information related to events, obstacles, motion information, and reaction information. The radar module 300 may process this information for provision to a central sensor fusion (not shown) that uses this information to assist in the alert warning module 312 operation and the appropriate response. Where the user is slow to respond to an alert warning, the system may increase the volume or brightness of an alert over where the user is quick to react. Other considerations, predictions and actions may be implemented.

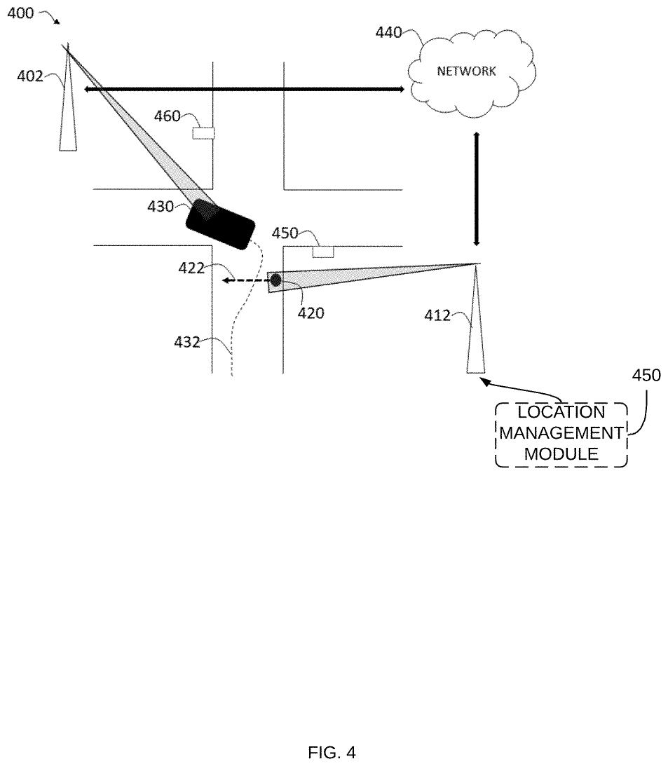

FIG. 4 illustrates a portion of a communications system 400, such as a 5G system. As discussed above, in a 5G network the base station operates differently. This presents a new type of infrastructure to work with the directional transmissions from the base station in a 5G system. High frequency signals do not have the range of their prior network counterparts and thus require repeaters and reflectarrays to maintain the connections and coverage areas. These and other devices extend the range of high frequency radios. Repeaters are used to amplify a signal to continue its path or change path direction. A reflectarray is used to change the direction of the signal to reach non-line-of-sight (NLOS) areas. The reflect array may be a passive device that reflects the signal from the base station to a specific location outside the direct line-of-sight (LOS) of the base station.

As illustrated in FIG. 4, a system 400 having multiple base station radios, such as 402, 412, communicates with individual users and devices within their reach. In the present instance, the base station 412 is in communication with user mobile device 420, and the user is moving across the street as indicated by path 422. Base station 402 is in communication with a mobile device 430 in a vehicle which is traveling as indicated by path 432. Each of the base stations 402, 412, is a 5G network device and during communications is able to track the user or other device/party to the communication. This means that base station 412 has a location indication of mobile device 420. The mobile device 420 may also be able to predict the path of the user, and this information may be used by the mobile device 420 or provided to the base station 412. Similarly, the base station 402 has a location indication of mobile device 430, which may be a built-in unit within the vehicle. The mobile device 430 may also be able to predict the path of the vehicle. In an autonomous vehicle this information is known with specificity. Where the traffic signals and/or road are able to provide information to the drivers and vehicles, the mobile device 430 may access additional information to enhance the path with timing information. In this way, the mobile device 430 may determine when the vehicle will be at a particular point in the path, such as where paths 422 and 432 intersect.

The base stations 402, 412 communicate with each other through network 440. In one example, network 440 determines there is a potential collision of the mobile devices and sends alerts to one or both parties through their respective base stations. The network alert is received and triggers an alert on the mobile device. In the vehicle, the alert may instruct the sensor fusion to take action to avoid a collision or warn the driver.

In some examples, the base stations 402, 412 communicate with each other directly. In some situations, the base stations communicate mobile devices by way of intermediate infrastructure elements, including repeater 450 that extends the reach of base station 412, and reflectarray 460 that amplifies the signals from base station 402. This further enables communication of the base stations with individual users.

For a mobile device without a radar module, the network detection of a trigger situation may be communicated to the mobile device through communications through base stations. An application may be added to a mobile device adding this type of functionality such as for a 5G wireless device, thus enabling the communications infrastructure components to provide alerts to the user of the mobile device. The 5G base station, and other networks, have location management features to identify a location of a user through direction of arrival (DoA) estimation techniques using the uplink (UL) signals. In the system 400 the base station 412 has a location management module (LMM) 450. The system is a location-aware network as it uses this information to direct antenna beams to users. This information is also used for proactive radio resource management (RRM) and will develop as these networks spread out over the world. This information may be used by the individual mobile devices as well as the infrastructure elements to understand the location and movement of wireless devices in a network.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

The previous description of the disclosed examples is provided to enable any person skilled in the art to make or use the present disclosure. Various modifications to these examples will be readily apparent to those skilled in the art, and the m spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item).The phrase “at least one” of does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A mobile device, comprising:
a transceiver for communication;
a sensing unit for environmental detection; and
an alarm module to provide an alarm on detection of an environmental condition.

2. The mobile device as in claim 1, wherein the environmental condition is activity in the environment around the mobile device.

3. The mobile device as in claim 1, wherein the environmental condition is a stationary object in a path of the mobile device.

4. The mobile device as in claim 1, wherein the environmental condition is a moving vehicle in a projected path of the mobile device.

5. The mobile device as in claim 1, wherein the sensing unit is a radar unit.

6. The mobile device as in claim 5, wherein the radar unit is designed to detect objects proximate to the mobile device.

7. The mobile device as in claim 1, wherein the alarm is one of an audio signal, a visual signal or a haptic signal.

8. The mobile device as in claim 1, wherein the alarm pauses a current service on the mobile device.

9. The mobile device as in claim 1, wherein the alarm provides an instruction to a user.

10. The mobile device as in claim 1, wherein the sensing unit is activated on movement of the mobile device.

11. A base station, comprising:
a transceiver module for receipt of signals from a wireless device and transmission of directional signals to the wireless device; and
a processing unit for processing received signals from the wireless device and determining a direction of arrival and estimating path movement of the wireless device, the processing unit adapted to receive activity information in proximity to the wireless device from a backhaul network,
wherein the transceiver transmits an alert to the wireless device when the activity information identifies a trigger situation.

12. The base station as in claim 11, further comprising a location management module (LMM) providing information in estimating the path movement of the wireless device.

13. The base station as in claim 12, wherein the trigger situation is a potential intersection of the path movement of the wireless device and an obstacle.

14. The base station as in claim 13, wherein the obstacle is a moving target.

15. The base station as in claim 11, wherein the obstacle is a stationary target.

16. The base station as in claim 1, wherein the alert is a message to activate a radar module on the wireless device.

17. The base station as in claim 1, wherein the alert is a message to pause a current service on the wireless device.

18. The base station as in claim 1, wherein the transceiver is adapted to communicate with a second wireless device to identify the trigger situation.

19. The base station as in claim 18, wherein the second wireless device is a vehicle.

20. A method for a mobile device, comprising:
activating a transceiver function;
activating a motion sensor;
when motion is detected for the mobile device, activating a sensing unit for environmental detection; and
when the sensing unit detects a trigger situation, initiating an alert on the mobile device.
